(19) United States
(12) Patent Application Publication
(10) Pub. No.: US 2014/0286010 A1
(43) Pub. Date: Sep. 25, 2014

(54) Luma Lights

(71) Applicant: Steve McLaren, Moraga, CA (US)

(72) Inventor: Steve McLaren, Moraga, CA (US)

(21) Appl. No.: 14/219,926

(22) Filed: Mar. 19, 2014

Related U.S. Application Data
(60) Provisional application No. 61/803,417, filed on Mar. 19, 2013.

(51) Int. Cl. F21S 4/00; F21K 99/00

(52) U.S. Cl. CPC F21S 4/001; F21K 9/00
USPC 362/249.02; 362/249.16

(57) ABSTRACT

The invention provides an all in one self contained system of electrically powered Christmas luminaries that are produced in a clear or translucent plastic container that provides the visual effect of a glass lantern. These luminary lights are installed and displayed along sidewalks and curbs.

### CLAIM OF PRIORITY

This patent application claims priority under 35 USC 119 (e) (1) from U.S. Provisional Patent Application Ser. No. 61/803,417 filed Mar. 19, 2013, of common inventorship herewith entitled, “LumaLights.”

### FIELD OF THE INVENTION

The present invention pertains to the field of electrical lighting, and more specifically to the field of celebratory decorative seasonal lighting.

### BACKGROUND OF THE INVENTION

The prior art has put forth several designs for holding luminary lights or candles. Among these are:

U.S. Pat. No. 5,791,774 to Roger D. Briles describes an outdoor illumination device of the type used for holiday decoration by aligning a plurality of such illumination devices in a linear array. This device includes a body having walls forming a cavity therein with a base formed at one end thereof and an access opening formed at an opposite end thereof. The body is configured for emission of at least some light when illumination occurs within the cavity. An assembly for supporting the candle forms a base with an assembly for supporting an electric lamp socket formed in the base with the candle support assembly and the electric lamp support assembly being juxtaposed and configured for non simultaneous accommodation of a candle and an electric lamp.

U.S. Pat. No. 4,184,195 to Charles P. Duncan describes a candle lamp made up of a light transmitting, heat resistant chimney that contains and supports a vertically moveable candle holder connected to a candle lifter that extends down through an opening in the bottom of the chimney. A suitable combustion air supply opening is provided in the lower area of the chimney, the chimney typically having a top opening that is substantially smaller than the maximum chimney width.

U.S. Pat. No. 470,458 to Jerome I. Vogeler describes a bottle intended for perfumery which is adapted after contents are exhausted to be used as a toy lantern. The body of the bottle is made of colored glass and is in the shape of a lantern, there being bars molded on the exterior surface to represent ordinary wire guard bars. This body is open at the top and bottom. These openings are outfitted with removable corks, to be removed after perfume is exhausted. An illuminating taper is inserted in these openings to present the appearance of a lighted lantern. When adapted as a lantern, this invention is applicable to decorating Christmas trees and shrubbery for night time festivals.

None of these prior art references describe the present invention.

### SUMMARY OF THE INVENTION

It is an object of the present invention to provide an all in one lighting system containing electrically powered luminaries for outdoor or indoor decorations.

### BRIEF DESCRIPTION OF THE DRAWINGS

FIG. 1 is a close up functional view showing a clear or translucent plastic luminary that resembles a glass lantern and contains a C9 or LED bulb.

FIG. 2 is a perspective functional view showing the present invention installed along sidewalk and curbside and illuminating a front lawn with additional Christmas light decorations on the lawn.

FIG. 3 shows a series of three luminaries installed along the ground with small stakes attached to the running power cord.

### DETAILED DESCRIPTION OF THE INVENTION

Christianity is the world's largest religion with over two billion adherents worldwide. For Christian believers, two pivotal celebrations of the year are Christmas honoring the miraculous birth of Jesus and Easter commemorating the death and resurrection of Jesus. Like all religions, Christianity is influenced by and incorporated folk and mythic traditions that existed before Christianity. Christmas is celebrated a few days after Winter Solstice. Easter occurs just after the Vernal Equinox and celebrates a spring like renewal of the soul. Celebrated by many people for thousands of years, solstices and equinoxes are turning points in each solar year. Both Stonehenge and Egyptian pyramids are widely believed to have functioned in large part as massive solar calendars.

In ancient times, plants and trees that remained green all year had a special meaning for people in the winter. Just as people today decorate their homes during the Christmas season with pine, spruce and fir trees, ancient people also hung evergreen boughs over their doors and windows. Decorating an indoor evergreen Christmas tree began with German Protestant Christians in the sixteenth century. To Christian and non Christians today, Christmas is a wonderful holiday symbolized by love, gift giving, music and carols, decorated trees, sleigh bells ringing, silent snowfalls, city lights, holiday lighting display, and festive food and parties. To become reality, these Christmas wonderments involve a lot of work and expense.

Homeowners go to their attic or garages shortly after Thanksgiving and begin a laborious process of unpacking boxes, untangling the strings of lights, checking them over, then breaking out the ladder and painstakingly stringing these lights around trees, posts and pillars to decorate house and yard. This part of the Christmas season is tedious and time consuming.

In many neighborhoods, a practice of putting out luminaries has become a tradition as well, and there is a lot of work involved. An individual stocks up on paper bags, places them at appropriate intervals along the curb or sidewalk, fills them with sand, puts in a candle that lasts maybe one evening, lights each candle one by one, and then admires their beauty while hoping the candles stay lit or refrain from setting the neighborhood on fire. Lovely as they are, luminaries as presently assembled are a major hassle.

The present invention, hereinafter referred to as Luma Lights, is an all in one self contained system of electrically powered Christmas luminaries that are produced in a clear or translucent plastic container that provides the visual effect of a glass lantern. These luminary lights are installed and displayed along sidewalks and curbs. Clean and simple, aesthetically beautiful and reusable for season after season, Luma Lights are functional for household consumers, business and institutional establishments who decorate for holidays and other special occasions.

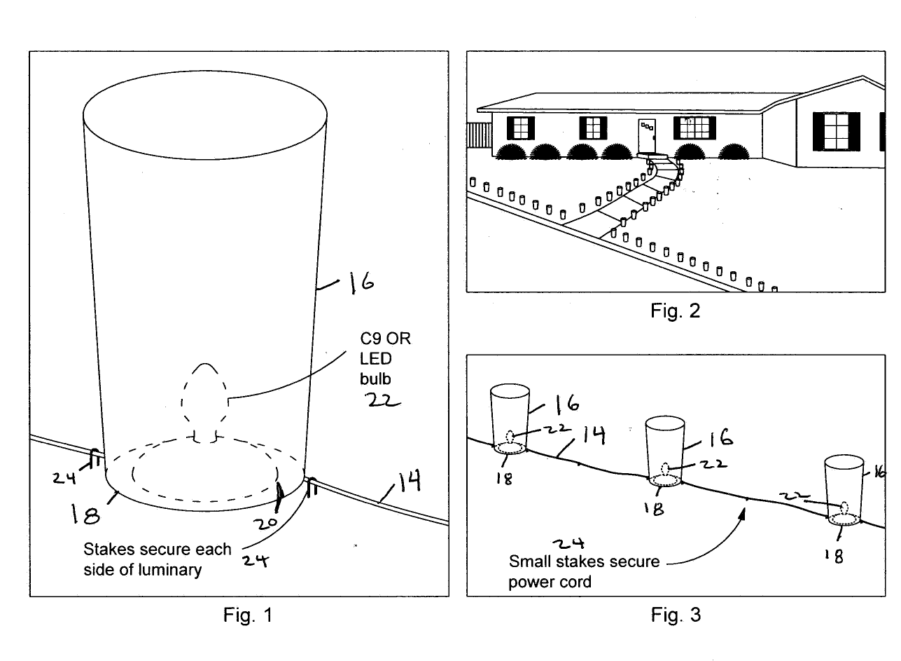

Please refer to the FIGS. 1 and 3. The present invention is constructed with an approximately twenty five foot cord 14 comprised of a series of clear rounded or cylindrical globes 16 having an open top. The globes 16 can be pre weighted with a bottom ring, of metal or a rubber sheathed ring filled 18 with sand or lead shot. The globes 16 measure approximately nine and one half inches in height and thirteen and one half inches in circumference. A form fitting opening or recess 20 resides in the center bottom of each globe, sealed with a thread or snap tight rubber gasket to receive and securely hold an illuminating bulb 22. The lighting cord 14 is produced in sections to permit joining several cords into one extended length. The recommended bulbs 22 are plastic LEDs. The globe and bulb assemblies are spaced at intervals of approximately two feet. The cord is equipped with attached or detached anchoring stakes 24 for securing the cord 14 length in the ground.

The user simply inserts bulbs into receiving holes in pre weighted globes while setting up Luma Lights along a curb, sidewalk or driveway. One example of placement is shown in FIG. 2. After setting out globe and bulb assemblies and staking down the cord, Luma Lights are powered by an extension cord throughout the holiday season, then disassembled and stored for use again the following year. Luma Lights are simple to assemble, easy to set out and take up again, eminently affordable and far superior to traditional paper bag and candle versions in both ease of use and potential fire hazard. The clear plastic globes provide a viewer with an impression of clear glass globes or lamp chimneys, for a warm and delightful holiday visual effect.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An all in one lighting system containing electrically powered luminaries for outdoor or indoor decorations, comprising:
a series of clear rounded or open topped cylindrical globes having a bottom and cylinder wall, wherein the globes are spaced apart along an electrical cord, and wherein the globes receive a bulb at a center of the bottom of the globe.

2. The lighting system of claim 1 wherein the globes further comprise a bottom ring of metal or a rubber sheathed ring filled with sand or lead shot.

3. The lighting system of claim 1 wherein each globe measures approximately nine and one half inches in height and thirteen and one half inches in circumference.

4. The lighting system of claim 1 further comprising a form fitting opening or recess in the center of the bottom of each globe, wherein the form fitting opening or recess is sealed with a thread or snap tight rubber gasket to receive and securely hold an illuminating bulb.

5. The lighting system of claim 1 wherein the electrical cord is produced in sections to permit joining several cords into one extended length.

6. The lighting system of claim 1 wherein the bulbs are plastic LED lights.

7. The lighting system of claim 1 wherein the globes are spaced at intervals of approximately two feet.

8. The lighting system of claim 1 wherein the cord is equipped with attached or detached anchoring stakes for securing the electrical cord length in the ground.
